(19) United States
(12) Patent Application Publication
(10) Pub. No.: US 2010/0080987 A1
(43) Pub. Date: Apr. 1, 2010

(54) POLYMERIC FILMS TO ENHANCE CELL GROWTH

(75) Inventors: Richard Brendon Timmons, Arlington, TX (US); Dhiman Bhattacharyya, St. Louis, MO (US); Kytai Troung Nguyen, Grand Prairie, TX (US); Hao Xu, Arlington, TX (US)

Correspondence Address: CHALKER FLORES, LLP, 2711 LBJ FRWY, Suite 1036, DALLAS, TX, 75234, US

(73) Assignee: Board of Regents, The University of Texas System, Austin, TX (US)

(21) Appl. No.: 12/568,494

(22) Filed: Sep. 28, 2009

Related U.S. Application Data
(60) Provisional application No. 61/100,614, filed on Sep. 26, 2008.

(51) Int. Cl. C08F 2/46; B32B 5/00

(52) U.S. Cl. 428/336; 427/488

(57) ABSTRACT

The present invention provides a method for creating surface-tailored polymer coating for improved cells proliferation by converting one or more carbonaceous monomers each comprising one or more functional groups to a monomer vapor; contacting the monomer vapor and a substrate; and igniting a radio frequency plasma glow discharge to polymerize the monomer vapor to form surface-tailored polymer coating on the substrate at a thicknesses of between 25 and 300 nm and has a functional group surface density of between 3 and 9%, wherein the surface-tailored polymer coating enhances cell proliferation.

### CROSS-REFERENCE TO RELATED APPLICATIONS

This application claims priority to U.S. Provisional Application Ser. No. 61/100,614, filed Sep. 24, 2008, the contents of which is incorporated by reference herein in its entirety.

### STATEMENT OF FEDERALLY FUNDED RESEARCH

This invention was made with U.S. Government support under Contract No. 1 R15 HL082644-01, entitled “Enhanced Endothelialization for Vascular Tissue Engineering Applications” awarded by the NIH. The government has certain rights in this invention.

### TECHNICAL FIELD OF THE INVENTION

The present invention relates in general to the field of the plasma polymerization, and more particularly, to novel compositions and methods for making surface tailored materials to enhance the growth rates of cells under in vitro and in vivo conditions.

### BACKGROUND OF THE INVENTION

Without limiting the scope of the invention, its background is described in connection with plasma polymerization, and, more particularly, to the development of surface tailored materials to enhance the growth rates of cells under both in vitro and in vivo conditions. Given the current state of the art, there is a need to optimize surface modification techniques for polymeric films to achieve improved cell growth.

For example, U.S. Pat. No. 5,876,753, entitled, “Molecular tailoring of surfaces” incorporated by reference, discloses an approach to three-dimensional molecular tailoring of surfaces using a plasma deposition step initially employed to deposit reactive functional groups on the surface of a solid substrate followed by immersion of the coated substrate in a solution during which time solute molecules react with the functional surface groups introduced during the plasma process. Solute molecules are attached to the surface during this second step. This simple two-step process is of general utility in that both the nature of the plasma introduced surface group and the nature of the solute molecules can be varied. Additionally it is possible to provide exact control of the surface density of reactive groups introduced during the plasma process and thus the concentration of solute molecules coupled to the solid surfaces. A particularly significant aspect of this invention is that the second step chemical derivatization reactions can be carried out using aqueous solutions at room temperature. The RF plasma polymerization of substituted perfluorohexenes is shown to produce films having unusually high —CF₃ content. These films are produced under both pulsed and continuous-wave plasma deposition conditions. The relative —CF₃ content of these polymers increases with decreasing average RF power absorbed during the film formation processes. The films produced under the least energetic condition (i.e., pulsed plasma, 0.1 ms on/3.0 ms off and 100 watts peak power) are exceptionally hydrophobic, exhibiting advancing and receding water contact angles in excess of those observed with Teflon® surfaces. The most hydrophobic films have a—CF₃ content which represents 40% of the carbon atoms present in the sample.

U.S. Pat. No. 6,214,423 entitled, “Method of forming a polymer on a surface” incorporated by reference, discloses pulsed plasma deposition of polymers as dielectrics for integrated circuit interconnects fills minimal gaps and yields a porous polymer with thermal stability by plasma off times sufficiently long to dissipate plasma on time energy input plus an anneal of the deposited polymer to drive off occluded monomers and small oligomers.

U.S. Pat. No. 5,932,296 entitled, “Process for producing a surface coated with amino groups” incorporated by reference, discloses a surface coated with amino groups is produced by applying a polymerizable amine to a surface by means of a pulsed plasma. The coated surfaces obtained thereby have a high density of amino groups so that a specific binding phase can be obtained by covalently binding a partner of a specific binding pair to the surfaces coated with amino groups.

Despite improvements in tissue engineering, other limitations exist in optimizing proliferation in recalcitrant tissue types; in particular, endothelial and fibroblast cells.

### SUMMARY OF THE INVENTION

The needs of the invention set forth above as well as further and other needs and advantages of the present invention are achieved by the embodiments of the invention described herein below.

The present invention provides a method for creating surface-tailored vinyl acetic polymer coating for improved cells proliferation by converting one or more vinylacetic acid monomers each comprising one or more —COOH groups to a monomer vapor, contacting the monomer vapor and a substrate, and igniting a radio frequency plasma glow discharge to polymerize the monomer vapor to form surface-tailored vinyl acetic polymer on the substrate at a thicknesses of between 25 and 300 nm and a —COOH group surface density of between 3.6 and 9%, wherein the surface-tailored vinylacetic acid polymer enhances cell proliferation.

The present invention also provides a method for creating surface-tailored polymer coating for improved cells proliferation by converting one or more carbonaceous monomers each comprising one or more functional groups to a monomer vapor; contacting the monomer vapor and a substrate; and igniting a radio frequency plasma glow discharge to polymerize the monomer vapor to form surface-tailored polymer coating on the substrate at a thicknesses of between 25 and 300 nm and has a functional group surface density of between 3 and 9%, wherein the surface-tailored polymer coating enhances cell proliferation.

The present invention provides a surface-tailored polymer coated substrate with improved cells proliferation characteristics having a substrate have a 25 and 300 nm vapor deposited polymer coating comprising one or more functional groups with a functional group surface density of between 3 and 9%, wherein the 25 and 300 nm vapor deposited polymer coating enhances cell proliferation.

The present invention provides a method improving cell proliferation on a substrate by providing a substrate; contacting the substrate with a monomer vapor comprising one or more vinylacetic acid monomers each having one or more —COOH groups; and igniting a radio frequency plasma glow discharge to polymerize the monomer vapor to form surface-tailored vinyl acetic polymer on the substrate at a thicknesses of between 25 and 300 nm and a —COOH group surface density of between 3.6 and 9%, wherein the surface-tailored vinylacetic acid polymer enhances cell proliferation.

### BRIEF DESCRIPTION OF THE DRAWINGS

For a more complete understanding of the features and advantages of the present invention, reference is now made to the detailed description of the invention along with the accompanying FIGURES and in which:

FIG. 1 is an image that shows the FT-IR spectra for plasma polymerized vinylacetic acid films deposited under pulsed and continuous-wave plasma conditions;

FIG. 2 is an image that shows the High resolution C(1s) X-ray photoelectron spectra for plasma polymerized vinylacetic acid films deposited under pulsed and continuous-wave plasma conditions;

FIG. 3 is an image that shows AFM images of plasma polymerized vinylacetic acid surfaces for 100 nm thick films having different —COOH surface densities and different film thicknesses with constant 9% —COOH surface density;

FIG. 4 is an image that shows cell adhesion data on plasma polymerized vinylacetic acid films as a function of low, medium and high —COOH surface densities;

FIG. 5 is an image that shows cell proliferation plasma polymerized vinylacetic acid films as a function of low, medium and high —COOH surface densities;

FIG. 6 is an image that shows live cell images of adhesion and proliferation of HAEC and 3T3 fibroblasts grown on bare cell culture plates and on 9% —COOH containing poly-vinylacetic acid films;

FIG. 7 is an image that shows cell adhesion data on 9% —COOH containing plasma polymerized vinylacetic acid films as a function of film thickness;

FIG. 8 is an image that shows cell proliferation data on 9% —COOH containing plasma polymerized vinylacetic acid films as a function of thickness; and

FIG. 9 is an image that shows live cell images of adhesion and proliferation of HAEC and 3T3 fibroblasts grown on bare cell culture plates and on 200 nm thick 9% —COOH containing poly-vinylacetic acid films.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity, but include the general class of which a specific example may be used for illustration. The terminology herein is used to describe specific embodiments of the invention, but their usage does not delimit the invention, except as outlined in the claims.

Generally, all technical terms or phrases appearing herein are used as one skilled in the art would understand to be their ordinary meaning.

In one embodiment, the present invention includes the improvement, establishment and proliferation of cell growth rates by optimizing and controlling the surface density and thickness of polymeric films. Cell growth rates can be significantly enhanced by a combination of film composition and film thickness. Controlling the film composition by utilizing certain plasma polymerization techniques permits both exact control of film thickness and film composition. Exemplar coatings processes (in full or any portion) that may be used include self-assembled monolayers (SAM's), photoinitiated grafting, grafting, thermally initiated chemical vapor deposition (iCVD), and radio frequency glow discharge (RFGD), also identified as plasma enhanced chemical vapor deposition (PECVD) or plasma polymerization.

In one embodiment, any of a number of biocompatible and/or biodegradable polymers may be used with the present invention. Non-limiting examples of polymers include: polymer is selected from monomers include vinylacetic acid (VAA), monoethylenically unsaturated (C3-C9) carboxylic acid monomers, e.g., monocarboxylic and dicarboxylic acid monomers. For example, unsaturated monocarboxylic acids include acrylic acid (AA), methacrylic acid (MAA), .alpha.-ethacrylic acid, β-dimethylacrylic acid, vinylacetic acid, allylacetic acid, ethylidineacetic acid, propylidineacetic acid, crotonic acid, and acryloxypropionic acid. Suitable unsaturated dicarboxylic acid monomers include, for example, maleic acid, maleic anhydride, fumaric acid, itaconic acid, citraconic acid, mesaconic acid, methylenemalonic acid and corresponding alkali and metal salts thereof. Other suitable acidic monoethylenically unsaturated monomers include the partial esters of unsaturated aliphatic dicarboxylic acids (alkyl half esters); for example, the alkyl half esters of itaconic acid, fumaric acid and maleic acid wherein the alkyl group contains 1 to 6 carbon atoms (methyl acid itaconate, butyl acid itaconate, ethyl acid fumarate, butyl acid fumarate and methyl acid maleate). Preferably, the monoethylenically unsaturated (C3-C9)carboxylic acid monomers are selected from one or more of acrylic acid, methacrylic acid and corresponding alkali and metal salts thereof.

Although the examples listed herein are in reference to specific monomers and polymers the skilled artisan will recognize that there are numerous monomers and polymers can be used including saturated and unsaturated monomers and various hydrocarbons. Examples of such monomers include (meth)acrylic esters, such as (meth)acrylates, alkyl (meth)acrylates, halogenated alkyl (meth)acrylates, siloxanylalkyl (meth)acrylates, fluoro(meth)acrylates, hydroxyalkyl (meth)acrylates, polyethylene glycol (meth)acrylate, (meth)acrylic esters of polyhydric alcohols, and vinyl (meth)acrylate; acrylamide and derivatives thereof; styrene and derivatives thereof; vinyl compounds, such as N-vinyllactams and vinyl (poly)carboxylate; butylene; and allyl compounds, such as allyl (poly)carboxylates and allyl carbonate.

Other specific examples of these monomers are ethylene, propylene, butylene, isobutylene, diisobutylene, vinyl chloride, vinylidene chloride, vinylidene bromide, vinyl alcohol, vinylacetic acid, a vinylsulfonic acid salt, vinyltoluene, cinnamic acid, vinylthiophene, vinylpyridine, vinylimidazole, styrene, methylstyrene, dimethylstyrene, chlorostyrene, dichlorostyrene, bromostyrene, p-chloromethylstyrene, divinylbenzene, acrylic acid, methyl acrylate, ethyl acrylate, n-butyl acrylate, phenyl acrylate, phenoxyethyl acrylate, tetrahydrofurfuryl acrylate, 2-hydroxyethyl acrylate, 2-hydroxypropyl acrylate, 2-acryloyloxyethylsuccinic acid, 2-acryloyloxyethylphthalic acid, methacrylic acid, methyl methacrylate, ethyl methacrylate, n-butyl methacrylate, 2-ethylhexyl methacrylate, isobornyl methacrylate, benzyl methacrylate, phenyl methacrylate, dicyclopentanyl methacrylate, dicyclopentenyl methacrylate, 2-methacryloyloxyethylsuccinic acid, 2-hydroxyethyl methacrylate, 2-hydroxypropyl methacrylate, 2-hydroxybutyl methacrylate; fumaric acid, maleic acid, itaconic acid, and esters of these acids; acrylonitrile, methacrylonitrile, acrylamide, N,N-dimethylacrylamide, N-vinyl-2-pyrrolidone, maleic anhydride, and N-substituted maleimide.

Suitable monomers includes monomers containing at least one of a functional group. The functional group surface density can between 0.5, 1, 1.5, 2, 3, 4, 5, 6, 7, 8, 9, 10, 11, 12, 13, 14, 15% and incremental variations thereof. The functional group surface density can be adjusted through the combination of monomers with and without functional groups to form a copolymer of functionalized and nonfunctionalized monomers. Alternative the functional group surface density can be adjusted through the processing steps, post processing steps, or through a combination of the methods above.

Although the examples listed herein are in reference to carboxylic acids functional groups the skilled artisan will recognize that there are numerous functional groups that may be used for example alkylcarbonyl, alkoxy, alkenyl, alkylene, alkyl, amines, amino, amido, imines, hydroxyls, esters, and carboxylic acids, halides, sulfides or combinations thereof.

The present invention may be used with any substrate that can withstand the conditions of the process. For example, low molecular weight polymers, implants, sutures, plates and devices may be coated. The present invention also includes a method of enhancing neuron, or nerve cell, growth. Scaffolds for tissue engineering (implantable matrices) can be coated with, polymers to enhance regeneration, growth or function of implanted cells or cells which migrate into, attach and proliferate within the implanted matrices. Materials which can be used for implantation include sutures, tubes, sheets, adhesion prevention devices (typically films, polymeric coatings applied as liquids which are polymerized in situ, or other physical barriers), and wound healing products (which vary according to the wound to be healed from films and coating to support structures). Both normal and genetically engineered nerve cells optionally can be seeded on the implants, to help replace lost function. These are generally interconnected pores in the range of between approximately 100 and 300 microns. The matrix should be shaped to maximize surface area, to allow adequate diffusion of nutrients and growth factors to the cells.

The adherence and growth rates of human aortic endothelial cells (HAEC) and 3T3-fibroblast cells on films obtained from polymerization of vinyl acetic acid were measured as functions of the surface density of —COOH groups and overall film thickness. Specifically, a pulsed plasma technique was employed to produce surfaces containing from 3.6 to 9% —COOH groups, expressed as a percent of total carbon content. It was observed that both cell lines exhibited increased cell adherence and proliferation with increasing —COOH surface densities. Additionally, and quite unexpectedly, the cell growth was also observed to depend on the employed film thicknesses, which ranged from 25 to 300 nm. The film thicknesses can ranged from 25 to 300 nm, e.g., 25, 26, 27, 28, 29, 30, 35, 40, 50, 100, 150, 200 300 and incremental changes thereof. Optimization of the functional group —COOH surface density and film thickness produced significant enhancements in initial cell adherence and growth; for example, an approximate 200% increase in the case of the HAEC cells. In addition to the practical significance of these results, this example illustrates the importance of specifying surface functional group densities and film thickness in future attempts to correlate and reconcile in vitro tissue culture data from different laboratories.

In light of needs such as those noted above, surface physical and chemical properties have been examined extensively to improve the overall biocompatibility of materials. In particular, a variety of surface functional groups have been evaluated with respect to achieving improved cell growth. Examples of such studies include amines (—NH₂), imines (═NH), hydroxyls (—OH), esters (—COOC—), and carboxylic acids (—COOH). A number of such studies have included comparisons of the effect of surface functional groups on cell adhesion and proliferation. In particular, several studies have shown that the presence of surface —COOH groups promote both improved cell attachment and growth compared to unmodified controls and, to some extent, improvement over other functional groups such as thiol (—SH), alcohol, esters, and hydrocarbons. However, it should also be noted, other reports have indicated that —COOH functionalized surfaces can reduce cell adhesion and proliferation, relative to the control surfaces, as reported in studies involving smooth muscle cells, endothelial cells and fibroblasts.

A variety of innovative approaches have been employed to immobilize different functional groups on solid surfaces. Examples of techniques employed for this purpose include self-assembled monolayers (SAM' s), photoinitiated grafting, grafting, radio frequency glow discharge (RFGD), also identified as plasma enhanced chemical vapor deposition (PECVD) or plasma polymerization, and thermally initiated chemical vapor deposition (iCVD).

The present study utilized the RFGD approach to deposit polymeric films containing —COOH groups, as obtained by the plasma polymerization of vinyl acetic acid. Tissue culture studies were carried out with these functionalized surfaces using endothelial and fibroblast cells. A distinguishing feature of the present invention, relative to prior studies of this type, is that cell adhesion and proliferation were examined as functions of both surface density of the —COOH groups and thickness of the plasma deposited polymer films. For this purpose, a pulsed plasma discharge was employed, in addition to the conventional continuous-wave (CW) operational mode. As shown previously with a variety of monomers, variation of the plasma duty cycle during the polymer formation represents an unusually convenient and exact method to control film composition. In the present work, the compositional control of interest was the extent of retention of monomer —COOH groups in the resultant films. Additionally, under a given pulsed plasma condition, the film deposition rate varies linearly with deposition time, thus providing a convenient control of film thickness.

### EXAMPLE 1

Effects of —COOH Surface Density and Film Thickness on the In Vitro Adherence and Proliferation of Endothelial and Fibroblast Cells. Deposition of poly(vinylacetic acid) film by RFGD plasma polymerization. Vinylacetic acid (VAA) was purchased from Sigma-Aldrich, St. Louis, Mo. and had a stated purity of 97%. The monomer was repeatedly freeze-thawed to remove any dissolved gases prior to use. Monomer vapor was subjected to radio frequency glow discharge (RFGD) at room temperature in a bell-shaped reactor chamber, as described elsewhere [25]. After substrates were placed inside the reactor, a background pressure of 4 mtorr was achieved. Monomer vapor was introduced into the chamber and an RF plasma glow discharge ignited. Three different power input conditions were employed, namely, pulsed discharges at duty cycles of 2/30 and 10/30 (time on/time off, ms), plus runs using the CW operational mode. All samples were prepared using a 150 W power input. Although all runs were carried out at a 150 W peak power, it is important to note that the average power input differs significantly in contrasting the pulsed and CW depositions. The average power is computed from the plasma duty cycle (ratio of on time to the sum of the on plus off time) multiplied by the peak power. Thus the average power inputs were 9.4 and 37.5 W for the 2/30 and 10/30 runs, respectively. Monomer pressure employed was 160 mtorr for the 2/30 polymerizations and 40 mtorr for the 10/30 and CW runs. The thicknesses of these deposited films were each ˜100 nm. In the second study involving film thickness variation, a single duty cycle (2/30) pulsed plasma was employed to polymerize VAA and the deposition time was varied accordingly to obtain different film thicknesses ranging from 25 nm to 300 nm. In all studies, standard polystyrene tissue culture well-plates (TCPS) were used as substrate for the plasma deposited films as well as the control samples in the cell culture measurements. Polished silicon wafers were used as substrates for XPS, AFM and water contact angle studies. All silicon wafers were treated with acetone, methanol and hexane to clean the wafer surface prior to use.

Characterization of plasma deposited poly(vinylacetic acid) films. The VAA polymeric films were characterized by FT-IR spectroscopy, X-Ray Photoelectron Spectroscopy (XPS), Atomic Force Microscopy (AFM) and water contact angle measurements. The FT-IR spectral analyses were carried out using a Bruker Vector-22 FT-IR spectrophotometer operated at 4 cm⁻¹ resolution on polymer films deposited on KBr disks. XPS spectra were obtained using a Perkin-Elmer PSI 5000 series instrument equipped with a monochromator and using a 8.95 eV pass energy. A neutralizer was used for all the measurements since the samples were non-conductive. Surface roughness of the deposited films was determined by using an AFM-SPM Nanoscope from Veeco. A phosphorus (n) doped silicon tip (RTESP from Veeco Probes) was used to scan the surfaces under taping mode operation. A Rame-Hart sessile drop goniometer was used to measure the static water contact angle of the polymeric films. Film thickness measurements were obtained using an Alpha step 200 profilometer. A metal tipped pen was employed to scratch a thin line in the polymer films deposited on polished silicon wafers. The thickness of the films reported is an average of three measurements taken for each sample.

Cell culture. HAECs (Cascade Biologics Inc., OR) were grown at 37° C. in Medium 199 (Invitrogen Corp., CA) supplemented with 5% FBS (Hyclone, Utah), Endothelial Growth Supplement (Cascade Biologics, OR), and 1% penicillin-streptomycin (Invitrogen, CA). 3T3 fibroblasts (ATCC, #CCL-92, VA) were grown at 37° C. in Dulbecco's Modified Eagle's Medium (DMEM, Invitrogen, CA) supplemented with 10% FBS (Hyclone, Utah), and 1% penicillin-streptomycin (Invitrogen, CA). Cells between passage 5 and 10 were used for all studies.

Cell adhesion and proliferation. For all adhesion and proliferation studies, cells were seeded at a density of 5×10³ cells/cm² on VAA plasma polymerized films coated on 12-well tissue culture well plates (TCPS). Untreated TCPS plates were employed as controls. After seeding, cells were incubated for 6 hours or 3 days for adhesion or proliferation studies, respectively. The media were changed every 48 hours. After these predetermined periods, live cell images were taken using a digital camera connected to an inverted microscope (Canon A640, Japan). Subsequently, culture plates were rinsed with PBS buffer (Invitrogen, CA) to remove unattached cells and attached cells were lysed with 1% Triton X-100 (MP Biomedicals, OH) for 30 minutes at 37° C. Cell lysates were used for analysis of total DNA of attached cells using a Pico Green dsDNA kit (Invitrogen, CA) following the manufacturer's instructions.

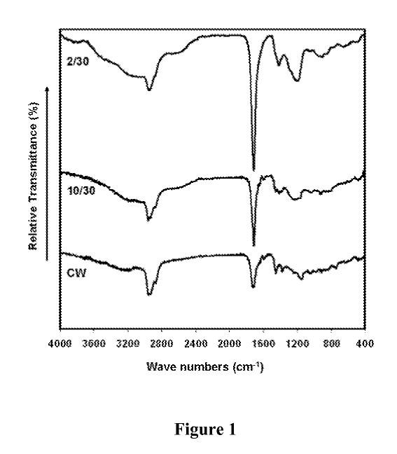

Characterization of the Polymer Films. FT-IR spectra of the plasma polymerized VAA films, although relatively qualitative in nature, show progressive changes in film composition with variations in the RF duty cycles employed during the film deposition process. FIG. 1 shows a plot of FT-IR transmission spectra of the poly-VAA films deposited at pulsed discharges at 2/30 and 10/30 on/off ratios (in ms) and under CW conditions, reading from top to bottom. These spectra reveal a progressive increase in the retention of the monomer's —COOH content with decreasing RF duty cycle employed during the deposition. This increase can be easily noted by comparing the relative intensities of the >C═O stretching frequency for COOH (1706 cm⁻¹) and the characteristic H-bonded —OH stretch for COOH (broad region from 3300 cm⁻¹ to 2500 cm⁻¹). Additionally, there is a progressive increase in the intensity of the C—O stretching vibration (˜1100 cm⁻¹) with decreasing RF duty cycle. These spectra reveal that the extent of >C═O retention is proportional to —OH retention in the film which would be consistent with the increasing presence of intact —COOH functional groups. It can also be noted that the intensities of the C—H (˜2900 cm⁻¹) absorptions, relative to the C—O containing moieties, increase with increasing RF duty cycle, which is consistent with the decreased retention of —COOH functionality as the plasma duty cycle is increased. FT-IR spectra were also obtained (not shown here) for the films of varying thicknesses. As expected, the absorption intensities of the C═O and C—O peaks increased as the thickness of the films increased but the overall spectral features were the same in all films.

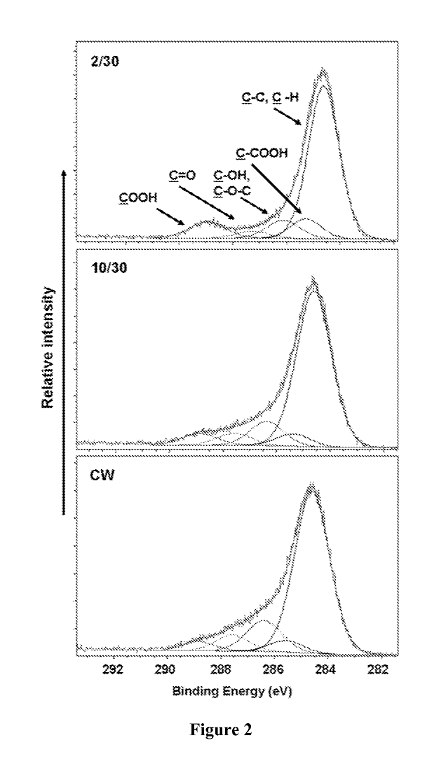

High resolution C(1s) XPS spectra are shown in FIG. 2, along with accompanying peak assignments. The peaks centered at 284.6 eV represents hydrocarbon signal, i.e. carbons not bonded to any oxygen atoms. The other peaks were fitted by following assignments; a β-shifted carbon bonded to carboxylic acid (C—COOH) at 285.3 eV, alcohol/ether (C—OH/C—O—C) at 286.3 eV, carbonyl (C═O) at 287.5 eV and carboxylic acid (COOH) at 288.9 eV. These peak assignments are in accord with many prior analyses of this type. Clearly, there is a progressive decrease in the number of carbon atoms assigned as —COOH as the plasma on time is increased in the order of 2/30, 10/30 to CW mode. Table 1 provides a quantitative measure of the percent surface carbon functionalities obtained from integration of the deconvoluted XPS high resolution C(1s) peaks. As these data show, there is a steady decrease in the —COOH functionality from ˜9% to ˜3.6% as the deposition condition switched from pulsed plasma (duty cycle, 2/30) to CW plasma operating mode. The progressive increase in the peak at 284.6 eV, as the plasma duty cycle is increased, is indicative of the increase in polymer cross-linking with increasing average power input. It should be noted explicitly, that films containing up to 20% —COOH groups can be obtained from the VAA monomer using even lower average power inputs than those reported here [29]. However, we observed that films containing in excess of the 9% —COOH were relatively unstable in aqueous solution, no doubt reflecting the lower degree of film cross-linking as the average power is decreased. For this reason, we limited the present study to films having a maximum —COOH surface density of 9%.

TABLE 1
Percent surface functional groups of the plasma polymerized vinylacetic
acid films deposited under pulsed (2/30 and 10/30) and CW plasma conditions

| | | | C—C, | | C—OH, | | |
|---|---|---|---|---|---|---|---|
| Plasma | Avg. power | O/C | C—H | C—COOH | C—O—C | C═O | COOH |
| conditions | input (W) | Ratio | 284.6 eV | 285.3 eV | 286.3 eV | 287.5 eV | 288.9 eV |
| 2/30 | 9.4 | 0.24 | 70.2 | 9.0 | 8.5 | 3.3 | 9.0 |
| 10/30 | 37.5 | 0.22 | 71.2 | 6.2 | 10.8 | 5.6 | 6.2 |
| CW | 150 | 0.19 | 72.6 | 3.6 | 13.6 | 6.6 | 3.6 |

High resolution C(1s) XPS spectra were also obtained for a series of films ranging in thickness from 25 to 300 nm, all deposited using the 2 ms on: 30 ms off pulsed plasma. Each of these films exhibited the same XPS spectrum as that shown in the top spectrum of FIG. 2, thus revealing no measurable polymer composition changes with increasing film thickness.

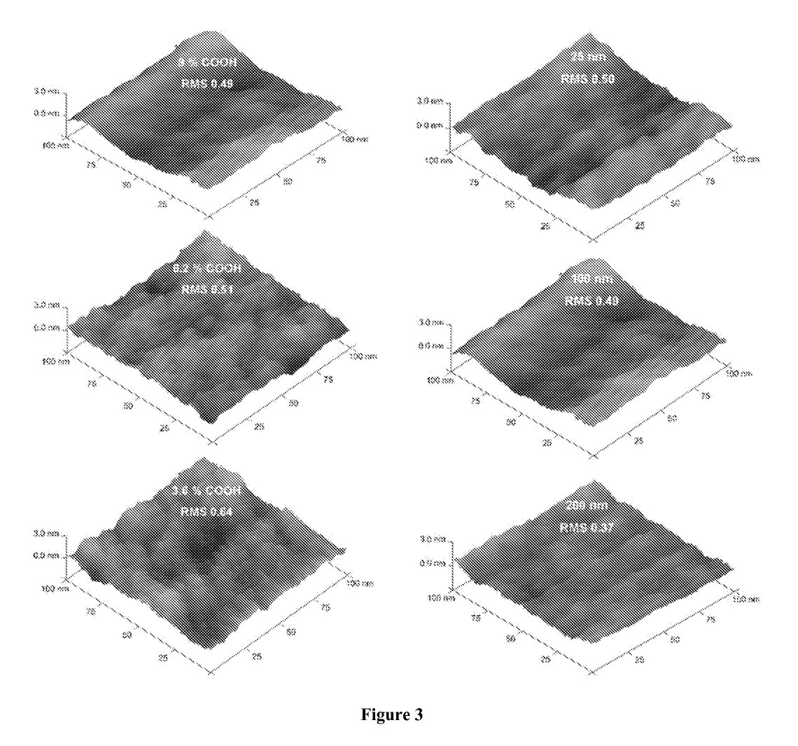

Prior studies have amply demonstrated that surface roughness can affect cellular behavior on surfaces. In particular, changes in the surface roughness in the micron range have been shown to effect cell attachment and morphology. For that reason, it was important that we examine the surface roughness of the films employed in the present study. The surface roughness of plasma deposited VAA films, made at conditions of 2/30 and 10/30 duty cycles and CW mode having film thicknesses 100 nm, as well as the films of different thicknesses (25 nm, 100 nm, 200 nm) deposited at the 2/30 duty cycle, were examined by AFM. The mean roughness values (RMS) shown in Table 2 are an average of three different regions of 100 nm×100 nm areas on each sample. As shown in FIG. 3, and tabulated in Table 2, relatively small changes, of the order of 0.15 nm, were observed in the root mean square roughness of the surfaces employed in this study. Little change in surface roughness was noted with variation of the film thickness produced at the constant 2/30 duty cycle. Surface roughness does not vary more than ±0.1 nm as the thickness of plasma polymerized VAA film increases from 25 nm to 200 nm. Given the fact that prior work involving morphology effects on cell growth indicate that such effects are noticeable only in the micron scale region, we can assume that the variations in cell adhesion and proliferation observed in this study were not due to any roughness variation effects of the plasma polymerized films.

The pulsed-wave radio frequency plasma glow discharge can have duty on cycles of 0.5, 1, 1.5, 2, 3, 4, 5, 6, 7, 8, 9, 10, 11, 12, 13, 14, 15, 16, 17, 18, 19, 20, 21, 22, 23, 24, 25 and incremental variations thereof. Similarly the pulsed-wave radio frequency plasma glow discharge can have duty off cycles of 10, 15, 20, 30, 40, 50, 60, 70, 80, 90, 100 and incremental variations thereof.

TABLE 2
AFM mean roughness values for plasma polymerized VAA films obtained
for different —COOH surface densities and film thicknesses.

| | | Avg. power | % COOH | |
|---|---|---|---|---|
| Plasma condition | | input (W) | retention | Roughness (RMS) |
| CW, 100 | nm | 150 | 3.6 | 0.64 ± 0.11 nm |
| 10/30, 100 | nm | 37.5 | 6.2 | 0.51 ± 0.11 nm |
| 2/30, 25 | nm | 9.4 | 8.9 | 0.50 ± 0.01 nm |
| 2/30, 100 | nm | 9.4 | 9.0 | 0.49 ± 0.01 nm |
| 2/30, 200 | nm | 9.4 | 8.8 | 0.37 ± 0.01 nm |

The water contact goniometer measurements obtained are summarized in Table 3. The contact angles shown represent the average of at least three measurements of each film. The measurements show a slight decrease in water contact angle with decreasing plasma on time (decreasing duty cycle). Lower contact angles clearly indicate the increased retention of polar groups, such as —COOH, on the surfaces as the plasma duty cycle is decreased, in accord with the spectroscopic data provided above. The water contact angle measurements are significant with respect to potential variations in non-specific protein binding to these surfaces. Although the amount of surface adsorbed proteins were not quantified, it is generally accepted that protein adsorption depends on the surface wettability, with adsorption being more pronounced on hydrophobic surfaces than on the hydrophilic ones. In the current study, the water contact angle (the wettability) of the films employed varied by only ˜10°, with the one exception of the sample produced under CW conditions (Table 3). Furthermore, the actual wettabilities, encompassing contact angles ranging from ˜40 to 60°, are in the range reported to be ideal for enhanced cell adhesion on polymer surfaces. Given these considerations, coupled with the fact that all measurements were carried out with media containing identical serum, it is assumed that the extent of non-specific protein adsorption did not differ significantly in these studies.

TABLE 3
Sessile drop water contact angles for plasma polymerized VAA films
having different —COOH surface densities and film thicknesses.

| | |
|---|---|
| Plasma conditions | Water contact angle after |
| (Duty cycle, thickness) | deposition (°) |

| | | |
|---|---|---|
| 2/30, 100 | nm | 38 ± 2 |
| 10/30, 100 | nm | 48 ± 3 |
| CW, 100 | nm | 60 ± 1 |
| 2/30, 25 | nm | 39 ± 1 |
| 2/30, 50 | nm | 38 ± 2 |
| 2/30, 200 | nm | 39 ± 2 |
| 2/30, 300 | nm | 38 ± 1 |

All of the plasma coated substrates employed in this study were subjected to overnight exposure in a vacuum oven at 40° C. prior to the spectral analyses and cell culture studies. This was taken as a precautionary step to eliminate any monomer molecules or oligomers which may have been incorporated in the films during the plasma polymerization depositions. Prior studies from our laboratory have revealed that trapping of low molecular weight species may occur, particularly for films produced at low plasma duty cycles.

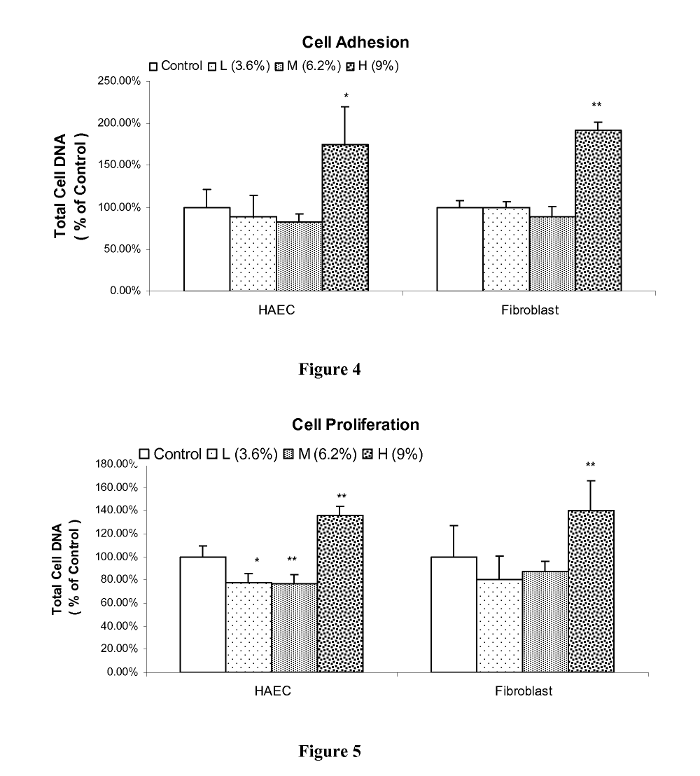

Cell adhesion and proliferation as a function of —COOH surface densities on films of identical thickness. The adhesion and proliferation reported in this section pertain to growth studies on 100 nm thick films having —COOH surface densities ranging from 3.6 to 9%. After incubation for 6 hours, both HAEC and 3T3 fibroblasts had significantly higher amounts (175-190%) of cells attached on VAA plasma polymerized films with high concentration (9%) of —COOH groups (p<0.05) compared to the 100% TCPS control. In contrast, polymers having lower concentration of —COOH (3.6% and 6.2%) did not increase the extent of cell attachment after 6 hours of incubation (FIG. 4) relative to the TCPS controls.

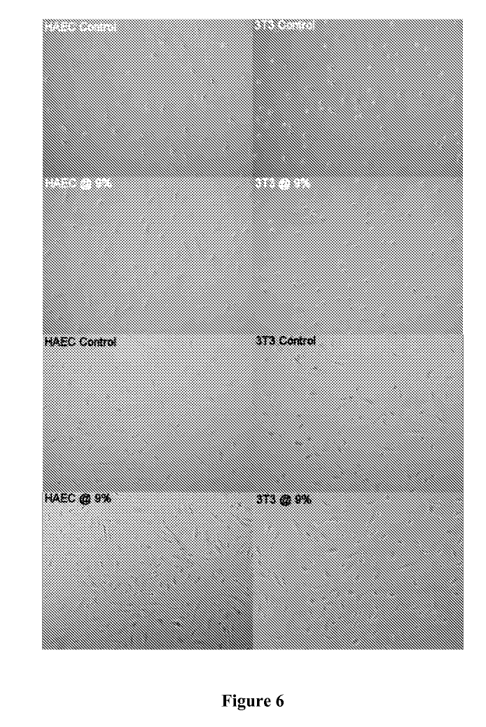

Cell proliferation results, obtained after three days of culture, parallel the adhesion data. That is, statistically significant higher amounts of HAEC and fibroblast cells were present on the VAA plasma polymerized films with high concentration (9%) of —COOH groups (p<0.01), but no enhanced proliferation was shown on the polymer surfaces containing the smaller density of these groups (FIG. 5). As shown in FIG. 6, normal cell morphology was observed for the higher surface coverage of both HAEC and the 3T3 fibroblast cells on the surfaces having high —COOH density relative to cell structure on the bare TCPS controls.

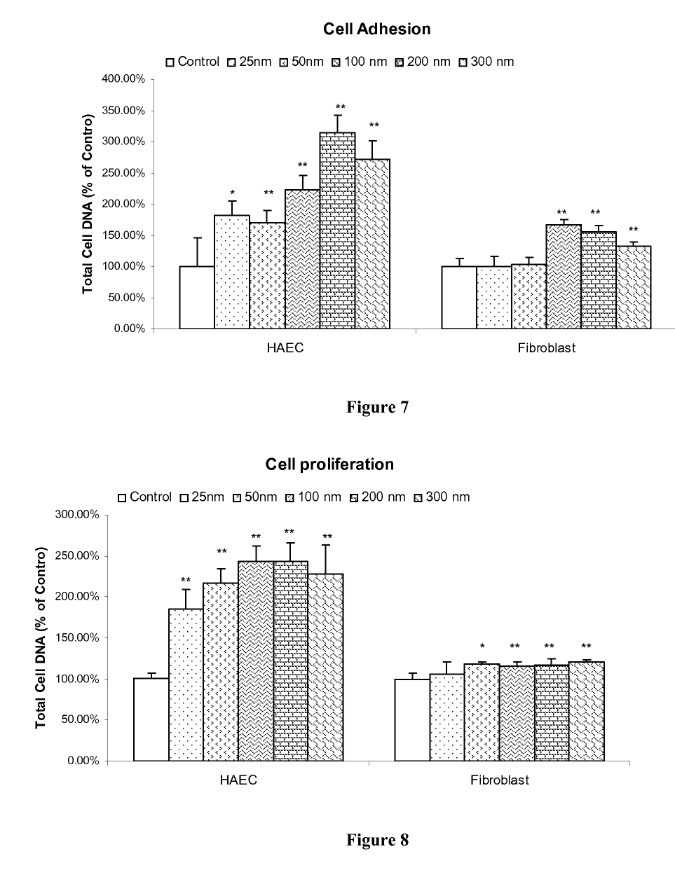

Cell adhesion and proliferation as a function of film thickness on polymer films having a constant surface density of —COOH groups. In these studies, polymer films all containing the high surface density —COOH groups (9%), but having film thicknesses ranging from 25 to 300 nm, were examined with respect to both cell adhesion and proliferation. As shown in FIG. 7, HAEC adhesion was significantly increased after 6 hours of incubation on all of these films. Interestingly, and unexpectedly, a significant increase in cell adhesion was observed up to film thickness of 200 nm. Fibroblast adhesion was also increased on 100, 200, and 300 nm thick —COOH containing polymer films, however, the extent of increase was much less than that obtained with the HAEC cells (FIG. 7).

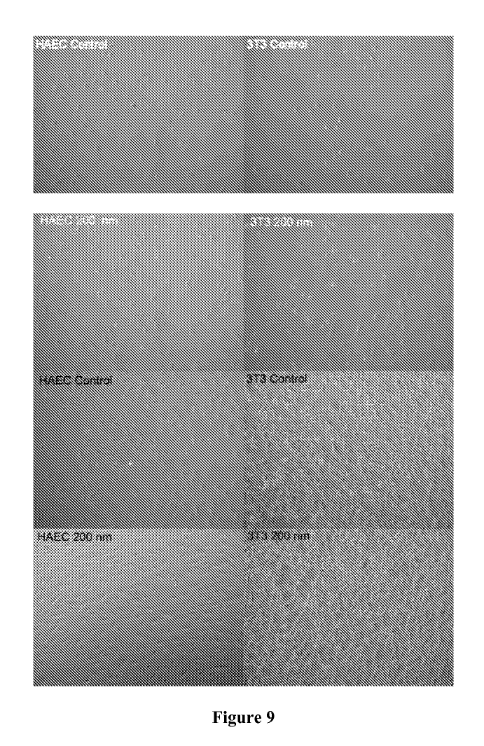

The cell proliferation results, obtained after the 3-day incubation period, were quite similar with the adhesion results. Namely, HAEC still had significantly higher cell growth on VAA plasma polymerized films, with the 100 nm and 200 nm thick films exhibiting the highest cell proliferation, some 2.5 times greater than the controls (FIG. 8). As also shown in FIG. 8, proliferation of the 3T3 fibroblasts on the —COOH surfaces were only slightly higher than those on the controls. Cells on all these substrates had normal morphologies (FIG. 9). The HAEC cells on the 100 nm and 200 nm thick polymer films had reached confluency, as shown in FIG. 9. The faster growing fibroblasts had reached confluent on all the films after 3 days, a fact which presumably minimized potential differences in growth rates on the different film thicknesses.

Given the essential constancy of surface roughness and surface wettabilities, we are able to focus on the effects of surface functional group densities and film thickness. The goal was to employ these variables as a possible route to achieve enhanced cell adhesion and growth rates on surfaces, an important objective particularly with respect to endothelial cells. In fact, both initial cell adhesion and cell proliferation are indeed effected by these variables, with the effects being far more significant with the HAEC cells (FIGS. 4, 5, 7 and 8). Dramatic increases in HAEC adhesion and growth were observed with both film composition and film thickness.

The magnitude of enhanced cell adhesion and proliferation observed in the present study is quite significant, particularly in the case of the HAEC cells. Additionally, the strong influence of film thickness on cell growth, again emphasizing the HAEC results, was unexpected. This particular aspect of cell growth does not appear to have been considered in quantitative fashion in previous studies of this type. In the SAMs work, the actual width of the —COOH containing portion of the surface would have been much smaller than the lowest film thickness (25 nm) employed in the present study.

Using the compositions and methods of the present invention, it was found that film compositions and morphologies did not change with thickness. Additionally, given the constancy of the film chemistry, it seems unlikely that these results can be attributed to differences in the concentration and distribution of initial non-specific protein adsorption. Nevertheless, with respect to practical considerations, the magnitude of cell growth enhancement achieved via this surface functional group and film thickness variation will hopefully prove to be useful. For example, using the 9% —COOH functionalized film and the optimum thickness of 200 nm, a 200% increase in initial HAEC cell adhesion was obtained and this increase translated into higher cell proliferation. Furthermore, the growth comparisons were made against a TCPS control, a standard generally acknowledged as being favorable towards cell growth. Given the acknowledged slow growth encountered in HAEC cell cultures on biomaterials, an increase of this magnitude is highly welcome.

It is contemplated that any embodiment discussed in this specification can be implemented with respect to any method, kit, reagent, or composition of the invention, and vice versa. Furthermore, compositions of the invention can be used to achieve methods of the invention.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

All publications and patent applications mentioned in the specification are indicative of the level of skill of those skilled in the art to which this invention pertains. All publications and patent applications are herein incorporated by reference to the same extent as if each individual publication or patent application was specifically and individually indicated to be incorporated by reference.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, MB, BBC, AAABCCCC, CBBAAA, CABABB, and so forth. The skilled artisan will understand that typically there is no limit on the number of items or terms in any combination, unless otherwise apparent from the context.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

### REFERENCES

1. Boyan B D, Hummert T W, Dean D D, Schwartz Z. Role of material surfaces in regulating bone and cartilage cell response. Biomaterials 1996; 17:137-146.
2. Kasemo B. Biological surface science. Surface Science 2002; 500:656-677.
3. WanY, Yang J, Yang J, Bei J, Wang S. Cell adhesion on gaseous plasma modified poly-(L-lactide) surface under shear stress field. Biomaterials 2003; 24:3757-3764.
4. Gumpenberger T, Heitz J, Bäuerle D, Kahr H, Graz I, Romanin C, Svorcik V, Leisch F. Adhesion and proliferation of human endothelial cells on photochemically modified polytetrafluoroethylene. Biomaterials 2003; 24:5139-5144.
5. Lakard S, Herlem G, Propper A, Kastner A, Michel G, Valles-Villarreal N, Gharbi T, Fahys B. Adhesion and proliferation of cells on new polymers modified biomaterials. Bioelectrochemistry 2004; 62:19-27.
6. Mitchell S A, Davidson M R, Emmison N, Bradley R H. Isopropyl alcohol plasma modification of polystyrene surfaces to influence cell attachment behavior. Surface Science 2004; 561:110-120.
7. France R M, Short R D, Duval E, Jones F R, Dawson R A, MacNeil S. Plasma copolymerization of allyl alcohol/1,7-octadiene: surface characterization and attachment of human keratinocytes. Chem Mater 1998; 10:1176-1183.
8. Zhang Z, Menges B, Timmons R B, Knoll W, Foerch R. Surface plasmon resonance studies of protein binding on plasma polymerized di(ethylene glycol) monovinyl ether films. Langmuir 2003; 19:4765-4770.
9. El Khadali F, Helary G, Pavon-Djavid G, Migonney V. Modulating fibroblast cell proliferation with functionalized poly(methyl methacrylate) based copolymers: chemical composition and monomer distribution effect. Biomacromolecules 2002; 3:51-56.
10. Ziegelaar B W, Fitton J H, Clayton A B, Platten S T, Maley M A, Chirila T V. The modulation of corneal keratocyte and epithelial cell responses to poly(2-hydroxyethyl methacrylate) hydrogel surfaces: phosphorylation decreases collagenase production in vitro. Biomaterials 1999; 20:1979-1988.
11. Bisson I, Kosinski M, Ruault S, Gupta B, Hilborn J, Wurm F, Frey P. Acrylic acid grafting and collagen immobilization on poly(ethylene terephthalate) surfaces for adherence and growth of human bladder smooth muscle cells. Biomaterials 2002; 23:3149-3158.
12. Gupta B, Plummer C, Bisson I, Frey P, Hilborn J. Plasma-induced graft polymerization of acrylic acid onto poly(ethylene terephthalate) films: characterization and human smooth muscle cell growth on grafted films. Biomaterials 2002; 23:863-871.
13. Haddow D B, Steele D A, Short R D, Dawson R A, MacNeil S. Plasma-polymerized surfaces for culture of human keratinocytes and transfer of cells to an in vitro wound bed model. J Biomed Mater Res 2003; 64A:80-87.
14. Barbosa J N, Barbosa M A, Aguas A P. Adhesion of human leukocytes to biomaterials: An in vitro study using alkanethiolate monolayers with different chemically functionalized surfaces. J Biomed Mater Res 2003; 65A:429-34.
15. Tidwell C D, Ertel S I, Ratner B D. Endothelial cell growth and protein adsorption on terminally functionalized, self-assembled monolayers of alkanethiolates on gold. Langmuir 1997; 13:3404-3413.
16. Arima Y, Iwata H. Effect of wettability and surface functional groups on protein adsorption and cell adhesion using well-defined mixed self-assembled monolayers. Biomaterials 2007; 28:3074-3082.
17. Elliott J T, Woodward J T, Umarji A, Mei Y, Tona A. The effect of surface chemistry on the formation of thin films of native fibrillar collagen. Biomaterials 2007; 28:576-585.
18. Faucheux N, Schweiss R, Lutzow K, Werner C, Groth T. Self-assembled monolayers with different terminating groups as model substrates for cell adhesion studies. Biomaterials 2004; 25:2721-2730.
19. McClary K B, Ugarova T, Grainger D W. Modulating fibroblast adhesion, spreading, and proliferation using self-assembled monolayer films of alkylthiolates on gold. J Biomed Mater Res 2000; 50:428-439.
20. Bearinger J P, Castner D G, Healy K E. Biomolecular modification of p(AAm-co-EG/AA) IPNs supports osteoblast adhesion and phenotypic expression. J Biomater Sci-Polym E 1998; 9:629-652.
21. Tang L, Wu Y, Timmons R B. Fibrinogen adsorption and host tissue responses to plasma functionalized surfaces. J Biomed Mater Res 1998; 42:156-163.
22. Chan K, Gleason K K. Initiated Chemical Vapor Deposition of Linear and Cross-linked Poly(2-hydroxyethyl methacrylate) for Use as Thin-Film Hydrogels. Langmuir 2005; 21:8930-8939.
23. Rinsch C L, Chen X, Panchalingam V, Eberhart R C, Wang J H, Timmons R B. Pulsed radio frequency plasma polymerization of allyl alcohol: controlled deposition of surface hydroxyl groups. Langmuir 1996; 12:2995-3002.
24. Wu Y J, Timmons R B, Jen J S, Molock F E. Non-fouling surfaces produced by gas phase pulsed plasma polymerization of an ultra low molecular weight ethylene oxide containing monomer. Colloids Surf B Biointerfaces 2000; 18:235-248.
25. Bhattacharyya D, Pillai K, Chyan O M R, Tang, L, Timmons R B. A New Class of Thin Film Hydrogels Produced by Plasma Polymerization. Chem. Mater 2007; 19:2222-2228.
26. Tarducci C, Schofield W C E, Badyal J P S, Brewer S A, Willis C. Monomolecular Functionalization of Pulsed Plasma Deposited Poly(2-hydroxyethyl methacrylate) Surfaces. Chem. Mater 2002; 14:2541-2545.
27. Timmons R B, Griggs A J. “Pulsed plasma polymerizations” in Plasma Polymer Films, Biedermann, H., editor. Imperial College Press: London, 2004. p. 217-245.
28. Beamson G, Briggs D. High-Resolution XPS of Organic Polymers, The Scienta ESCA300 Database; John Wiley & Sons: New York, 1992.
29. Qiu, H. Controlled chemical and morphological surface modifications via pulsed plasma polymerizations: synthesis of ultrahydrophobic surfaces. PhD thesis, University of Texas at Arlington, 2001.
30. Xu C, Yang F, Wang S, Ramakrishna S. In vitro study of human vascular endothelial cell function on materials with various surface roughness. J Biomed Mater Res A 2004; 71:154-161.
31. Miller D C, Thapa A, Haberstroh K M, Webster T J. Endothelial and vascular smooth muscle cell function on poly(lactic-co-glycolic acid) with nano-structured surface features. Biomaterials 2004; 25:53-61.
32. Kunzler T P, Drobek T, Schuler M, Spencer N D. Systematic study of osteoblast and fibroblast response to roughness by means of surface-morphology gradients. Biomaterials 2007; 28:2175-2182.
33. Scotchford C A, Gilmore C P, Cooper E, Leggett G J, Downes S. Protein adsorption and human osteoblast-like cell attachment and growth on alkylthiol on gold self-assembled monolayers. J Biomed Mater Res 2002; 59:84-99.
34. Lee J H, Lee J W, Khang G, Lee H B. Interaction of cells on chargeable functional group gradient surfaces. Biomaterials 1997; 18:351-358.
35. Haddow D B, France R M, Short R D, MacNeil S, Dawson R A, Leggett G J, Cooper E. Comparison of proliferation and growth of human keratinocytes on plasma copolymers of acrylic acid/1,7-octadiene and self-assembled monolayers. J Biomed Mater Res 1999; 47:379-387.
36. Cooper E, Wiggs R, Hutt D A, Parker L, Leggett G J, Parker T L. Rates of attachment of fibroblasts to self-assembled monolayers formed by the adsorption of alkylthiols onto gold surfaces. J Mater Chem 1997; 7:435-441.

What is claimed is:

1. A method for creating surface-tailored polymer coating for improved cells proliferation comprising the steps of:
converting one or more carbonaceous monomers comprising one or more functional groups to a monomer vapor;
contacting the monomer vapor and a substrate; and
igniting a radio frequency plasma glow discharge to polymerize the monomer vapor to form surface-tailored polymer coating on the substrate at a thicknesses of between 25 and 300 nm and has a functional group surface density of between 3 and 9%, wherein the surface-tailored polymer coating enhances cell proliferation.

2. The method of claim 1, wherein the one or more carbonaceous monomers comprise one or more vinyl acetic acid monomers, one or more acetic acid monomers, one or more ethylene acetic acid monomers or a combination thereof.

3. The method of claim 1, further comprising one or more carbonaceous monomers without functional groups to control the functional group surface density.

4. The method of claim 1, wherein the radio frequency plasma glow discharge is a continuous-wave radio frequency plasma glow discharge.

5. The method of claim 1, wherein the radio frequency plasma glow discharge is a pulsed-wave radio frequency plasma glow discharge.

6. The method of claim 5, wherein the pulsed-wave radio frequency plasma glow discharge has a duty cycles of 2 ms on and 30 ms off or 10 ms on and 30 ms off.

7. The method of claim 5, wherein the radio frequency plasma glow discharge has an average power input between 9.4 and 37.5 W.

8. The method of claim 1, wherein the substrate comprises a tissue culture plate.

9. The method of claim 1, wherein the thicknesses is between 25 and 200 nm.

10. The method of claim 1, wherein the one or more functional groups comprise amines (—NH₂), imines (═NH), hydroxyls (—OH), esters (—COOC—), and carboxylic acids (—COOH), halides, sulfides or combinations thereof.

11. A method for creating surface-tailored vinyl acetic polymer coating for improved cells proliferation comprising the steps of:
converting one or more vinylacetic acid monomers comprising one or more —COOH groups to a monomer vapor;
contacting the monomer vapor and a substrate; and
igniting a radio frequency plasma glow discharge to polymerize the monomer vapor to form surface-tailored vinyl acetic polymer on the substrate at a thicknesses of between 25 and 300 nm and a —COOH group surface density of between 3.6 and 9%, wherein the surface-tailored vinylacetic acid polymer enhances cell proliferation.

12. A surface-tailored polymer coated substrate with improved cells proliferation characteristics comprising:
a substrate have a 25 and 300 nm vapor deposited polymer coating comprising one or more functional groups with a functional group surface density of between 3 and 9%, wherein the 25 and 300 nm vapor deposited polymer coating enhances cell proliferation.

13. The surface-tailored polymer coated substrate of claim 12, wherein the one or more functional groups comprise amines (—NH₂), imines (═NH), hydroxyls (—OH), esters (—COOC—), and carboxylic acids (—COOH), halides, sulfides or combinations thereof.

14. The surface-tailored polymer coated substrate of claim 12, wherein the thicknesses is between 25 and 200 nm.

15. The surface-tailored polymer coated substrate of claim 12, wherein the 25 and 300 nm vapor deposited polymer coating comprises one or more ethylene acetic acid monomers, one or more vinylacetic acid monomers or a mixture thereof.

16. A method improving cell proliferation on a substrate comprising the steps of:
providing a substrate;
contacting the substrate with a monomer vapor comprising one or more monomers having one or more functional groups; and
igniting a radio frequency plasma glow discharge to polymerize the monomer vapor to form surface-tailored vinyl acetic polymer on the substrate at a thicknesses of between 25 and 300 nm and a functional group surface density of between 3.6 and 9%, wherein the surface-tailored polymer enhances cell proliferation.

17. The method of claim 16, wherein the one or more functional groups comprise amines (—NH2), imines (═NH), hydroxyls (—OH), esters (—COOC—), and carboxylic acids (—COOH), halides, sulfides or combinations thereof.

18. The method of claim 16, wherein the one or more monomers comprise one or more vinylacetic acid monomers, one or more acetic acid monomers, one or more ethylene acetic acid monomers or a combination thereof.

19. The method of claim 16, wherein the radio frequency plasma glow discharge is a continuous-wave radio frequency plasma glow discharge.

20. The method of claim 16, wherein the radio frequency plasma glow discharge is a pulsed-wave radio frequency plasma glow discharge.
